(19) United States
(12) Patent Application Publication
(10) Pub. No.: US 2025/0340725 A1
(43) Pub. Date: Nov. 6, 2025

(54) Polypropylene Copolymer With High Clarity and Toughness

(71) Applicant: W.R. Grace & Co.-CONN., Columbia, MD (US)

(72) Inventors: Jing Zhong, Columbia, MD (US); Jonathan Reeds, Columbia, MD (US); Amaia Montoya, Columbia, MD (US); Matt Fedec, Columbia, MD (US); Amit Gautam, Columbia, MD (US)

(21) Appl. No.: 18/867,066

(22) PCT Filed: May 19, 2023
(86) PCT No.: PCT/US2023/022975

§ 371 Date: Nov. 19, 2024

Related U.S. Application Data
(60) Provisional application No. 63/344,193, filed on May 20, 2022.

(51) Int. Cl. C08L 23/12; B29C 48/00; B29K 23/00; C08F 2/00; C08F 210/06

(52) U.S. Cl. CPC C08L 23/12; B29C 48/0017; B29C 48/022; C08F 2/001; C08F 210/06; B29K 2023/12; B29K 2023/16; B29K 2995/0026; B29K 2995/0089; C08L 2201/10; C08L 2205/025; C08L 2207/02

(57) ABSTRACT

Polypropylene polymer compositions with high transparency in combination with excellent impact resistance strength, and optionally excellent stiffness properties are provided, together with the methods of making such compositions. Such polypropylene polymer compositions also have low melt flow rates (e.g., 5 g/10 min or less or 4 g/10 min or less).

### CROSS REFERENCE TO RELATED APPLICATIONS

This application claims the benefit of priority to U.S. Provisional Patent Application No. 63/344,193 filed May 20, 2022, which is hereby incorporated by reference, in its entirety for any and all purposes.

### FIELD

The present technology is generally related to polypropylene polymer compositions having an improved balance of properties. More specifically, the polypropylene polymer compositions exhibit high clarity and toughness.

### BACKGROUND

Polyolefins, like polypropylene, are used in different demanding applications. As such, there is a continuous search for tailored polymers that can meet the requirements of these applications. For instance, heterophasic systems are known for their good impact behavior. Such heterophasic propylene copolymers comprise a crystalline matrix being either a propylene homopolymer or a random propylene copolymer in which an elastomeric copolymer, such as a propylene/ethylene copolymer, is dispersed.

This disclosure provides polypropylene compositions comprising a heterophasic propylene copolymer with high clarity and high stiffness/toughness and the corresponding methods for preparing such compositions. Such polypropylene compositions have an improved balance of properties over those disclosed in the prior arts and are suitable for use in thermoforming and extrusion blow molding applications.

### SUMMARY

In general, the present disclosure is directed to polypropylene polymer compositions having an improved balance of properties. The polypropylene polymer compositions made in accordance with the present disclosure, for instance, can be formulated to have high transparency in combination with excellent impact resistance strength. For instance, the polymer compositions described herein have a relatively low haze value while having excellent toughness properties. Additionally, these polymer compositions may also exhibit excellent stiffness properties.

The polypropylene polymer compositions described herein are prepared by combining a first polymer phase comprising polypropylene homopolymer or random copolymer combined with a second polymer phase comprising rubber-like propylene/ethylene copolymer. The selection of specific parameters for each polymer phase as described herein provides a polypropylene polymer composition with high transparency in combination with excellent impact resistance strength, and optionally excellent stiffness properties.

Provided in one aspect is a polypropylene composition comprising:
(a) a first polymer phase comprising a polypropylene homopolymer or random copolymer comprising optionally one or more comonomers in an amount of equal or less than about 3% by weight, based upon the total weight of the propylene homopolymer or copolymer, having a total cold xylene solubles content of from about 2% by weight to about 6% by weight, and having a melt flow rate of about 0.5 g/10 min to about 3 g/10 min; and
(b) a second polymer phase comprising a propylene/ethylene copolymer comprising ethylene in an amount of less than about 18% by weight, based upon the total weight of the propylene/ethylene copolymer;
   wherein the ratio of the melt flow rate of the polypropylene homopolymer or random copolymer to the melt flow rate of the propylene/ethylene copolymer is greater than about 1.0; and
   wherein the first polymer phase and the second polymer phase are combined to provide the polypropylene composition having a melt flow rate of about 4 g/10 min or less, an ethylene content of less than about 5% by weight, a total cold xylene solubles content of from about 5% by weight to about 20% by weight, a haze at 1 mm of less than about 20%, an IZOD impact strength at 23° C. of greater than about 500 J/m, a Gardner drop impact strength at 0° C. of greater than about 150 inch-lbs, and a flexural modulus of greater than or equal about 800 MPa.

In some embodiments, the first polymer phase comprises a crystalline matrix comprising the polypropylene homopolymer or random copolymer. In some embodiments, the polypropylene composition comprises a heterophasic propylene copolymer.

In some embodiments, the first polymer phase comprises the polypropylene homopolymer or random copolymer comprising one or more comonomers in an amount of from about 0% by weight to about 3% by weight, based upon the total weight of the propylene homopolymer or copolymer. In some embodiments, the first polymer phase comprises the polypropylene homopolymer or random copolymer having a total cold xylene solubles content of about 2.5% by weight or about 4.8% by weight. In some embodiments, the first polymer phase comprises the polypropylene homopolymer or random copolymer having a melt flow rate of from about 0.5 g/10 min to about 1.5 g/10 min. In some embodiments, the propylene/ethylene copolymer present in the second polymer phase comprises butene.

In some embodiments, the polypropylene composition has a melt flow rate of from about 0.5 g/10 min to about 1.5 g/10 min. In some embodiments, the polypropylene composition has an ethylene content of from about 2% by weight to about 4.5% by weight. the polypropylene composition has a total cold xylene solubles content of about 7% by weight or about 12% by weight. In some embodiments, the polypropylene composition has a haze at 1 mm of from about 5% to about 15%. In some embodiments, the polypropylene composition has an IZOD impact strength at 23° C. of from about 500 J/m to about 900 J/m.

In some embodiments, the polypropylene composition has a Gardner drop impact strength at 0° C. of from about 150 inch-lbs to about 350 inch-lbs. In some embodiments, the polypropylene composition has a flexural modulus of from about 800 MPa to about 1300 MPa.

Provided in another aspect is a polypropylene composition comprising:
(a) a first polymer phase comprising a polypropylene homopolymer or random copolymer comprising optionally one or more comonomers in an amount of equal or less than about 1% by weight, based upon the total weight of the propylene homopolymer or copolymer, having a total cold xylene solubles content of less than about 4% by weight, and having a melt flow rate of from about 2 g/10 min to about 5 g/10 min; and
(b) a second polymer phase comprising a propylene/ethylene copolymer comprising ethylene in an amount of less than about 18% by weight, based upon the total weight of the propylene/ethylene copolymer;
   wherein the ratio of the melt flow rate of the polypropylene homopolymer or random copolymer to the melt flow rate of the propylene/ethylene copolymer is greater than about 1.0; and
   wherein the first polymer phase and the second polymer phase are combined to provide the polypropylene composition having a melt flow rate of about 5 g/10 min or less, an ethylene content of less than about 3.5% by weight, a total cold xylene solubles content of from about 5% by weight to about 15% by weight, a haze at 1 mm of less than about 20%, an IZOD impact strength at 23° C. of greater than about 200 J/m, and a flexural modulus of greater than or equal about 1100 MPa.

In some embodiments, the first polymer phase comprises the polypropylene homopolymer or random copolymer comprising one or more comonomers in an amount of from about 0.5% by weight to about 1% by weight, based upon the total weight of the propylene homopolymer or copolymer. In some embodiments, the first polymer phase comprises the polypropylene homopolymer or random copolymer having a total cold xylene solubles content of from about 1% by weight to about 3% by weight. In some embodiments, the first polymer phase comprises the polypropylene homopolymer or random copolymer having a melt flow rate of from about 2 g/10 min to about 4 g/10 min. In some embodiments, the propylene/ethylene copolymer present in the second polymer phase comprises butene.

In some embodiments, the polypropylene composition has a melt flow rate of from about 2 g/10 min to about 4 g/10 min. In some embodiments, the polypropylene composition has an ethylene content of from about 2% by weight to about 3.5% by weight. In some embodiments, the polypropylene composition has a total cold xylene solubles content of from about 5.5% by weight or about 12% by weight. In some embodiments, the polypropylene composition has a haze at 1 mm of from about 10% to about 20%. In some embodiments, the polypropylene composition has an IZOD impact strength at 23° C. of from about 200 J/m to about 900 J/m. In some embodiments, the polypropylene composition has a flexural modulus of from about 1200 MPa to about 1600 MPa.

In any embodiment, the second polymer phase comprises a propylene/ethylene copolymer comprising ethylene in an amount of from about 10% by weight to about 18% by weight, based upon the total weight of the propylene/ethylene copolymer.

In any embodiment, the ratio of the melt flow rate of the polypropylene homopolymer or random copolymer to the melt flow rate of the propylene/ethylene copolymer is from about 1.0 to about 3.0.

In any embodiment, the polypropylene composition has a Gardner drop impact strength at 23° C. of greater than about 150 inch-lbs.

In any embodiment, the polypropylene composition further comprises one or more of a nucleator, an antacid, and an antioxidant. In some embodiments, the one or more nucleator is present in an amount of about 5000 ppm or lower.

In any embodiment, the one or more comonomers present in the polypropylene homopolymer or random copolymer comprises ethylene.

Also provided in another aspect is a molded article formed from any one of the polypropylene compositions described herein. In some embodiments, the molded article is an extrusion blow molded article.

Also provided in another aspect is a process for preparing any one of the polypropylene compositions described herein by sequential polymerization in the presence of a Ziegler-Natta catalyst, wherein:
preparing a first polymer phase in first gas phase reactor, and
transferring the first polymer phase to a second gas phase reactor comprising a second polymer phase;
wherein combining the first polymer phase with the second polymer phase provides the polypropylene composition.

Also provided in another aspect is a process for preparing any one of the polypropylene composition described herein comprising:
feeding propylene and optionally one or more comonomers into a first reactor; feeding into the first reactor a catalyst mixture comprising (1) a Ziegler-Natta catalyst, (2) a cocatalyst, and (3) an external donor;
contacting the propylene with the catalyst mixture under first polymerization conditions to polymerize propylene and optionally one or more comonomers to form a first polymer phase comprising a propylene homopolymer or copolymer;
transferring at least a portion of the first polymer phase to a second reactor; and
feeding additional propylene and ethylene into the second reactor to form a second polymer phase;
   wherein combining the first polymer phase with the second polymer phase provides the polypropylene composition.

Other features and aspects of the present disclosure are discussed in greater detail below.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the alkyl, alkenyl, aryl, or ether group, as defined below (e.g., an alkyl group) in which one or more bonds to a hydrogen atom contained therein are replaced by a bond to non-hydrogen or non-carbon atoms may be substituted. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. An alkyl group may be substituted one or more times. An alkyl group may be substituted two or more times. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, isopentyl groups, and 1-cyclopentyl-4-methylpentyl. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. An aryl group with one or more alkyl groups may also be referred to as alkaryl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

The term “alkoxy” group refers to a (alkyl)O-group, where alkyl is as defined herein.

The term “cycloalkyl” refers to a monocyclic or polycyclic aliphatic, non-aromatic group, wherein each of the atoms forming the ring (i.e. skeletal atoms) is a carbon atom. In some embodiments, cycloalkyls are spirocyclic or bridged compounds. In some embodiments, cycloalkyls are optionally fused with an aromatic ring, and the point of attachment is at a carbon that is not an aromatic ring carbon atom. Cycloalkyl groups include groups having from 3 to 10 ring atoms. In some embodiments, cycloalkyl groups are selected from among cyclopropyl, cyclobutyl, cyclopentyl, cyclopentenyl, cyclohexyl, cyclohexenyl, cycloheptyl, cyclooctyl, spiro[2.2]pentyl, norbornyl and bicyclo[1.1.1]pentyl. In some embodiments, a cycloalkyl is a C₃-C₆cycloalkyl. In some embodiments, a cycloalkyl is a monocyclic cycloalkyl. Monocyclic cycloalkyls include, but are not limited to, cyclopropyl, cyclobutyl, cyclopentyl, cyclohexyl, cycloheptyl, and cyclooctyl. Polycyclic cycloalkyls include, for example, adamantyl, norbornyl (i.e., bicyclo[2.2.1]heptanyl), norbornenyl, decalinyl, 7,7-dimethyl-bicyclo[2.2.1]heptanyl, and the like

The term “propylene/ethylene copolymer”, as used herein, is a copolymer containing a majority weight percent propylene monomer with ethylene monomer as a secondary constituent and does not present a well defined melting peak. A random copolymer is a polymer having individual repeating units of the comonomer present in a random or statistical distribution in the polymer chain that can be defined as crystalline as it shows a well defined melting peak.

Melt flow rate (MFR), as used herein, is measured in accordance with the ASTM D 1238 test method at 230° C. with a 2.16 kg weight for propylene-based polymers. When the sample before pelletization is measured (powder MFR) the polymer was mixed with antioxidants and antacid in a manner known to those skilled in the art before measuring the MFR to avoid degradation during the measurement.

Cold xylene solubles (XS) is defined as the weight percent of resin that remains in solution after a sample of polypropylene resin is dissolved in hot xylene and the solution is allowed to cool to 25° C. This is also referred to as the gravimetric XS method according to ASTM D5492-98 using a 90 minute precipitation time and is also referred to herein as the “wet method.” The procedure consists of weighing 2 g of sample and dissolving the sample in 200 ml o-xylene in a 400 ml flask with 24/40 joint. The flask is connected to a water cooled condenser and the contents are stirred and heated to reflux under nitrogen (N₂), and then maintained at reflux for an additional 30 minutes. The solution is then cooled in a temperature controlled water bath at 25° C. for 90 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m₃−m₂)*2/m_{1]}*100, where m₁ is the original weight of the sample used, m₂ is the weight of empty aluminum pan, and m₃ is the weight of the pan and residue (the asterisk, *, here and elsewhere in the disclosure indicates that the identified terms or values are multiplied). XS can also be measured according to the Viscotek method, as follows: 0.4 g of polymer is dissolved in 20 ml of xylenes with stirring at 130° C. for 60 minutes. The solution is then cooled to 25° C. and after 90 minutes the insoluble polymer fraction is filtered off. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A homopolymer, e.g. Dow 5D98, is used as a reference material to ensure that the Viscotek instrument wet method defined in the next paragraph return the same results and therefore can be used interchangeably.

Ethylene content of the either random ethylene copolymer and the ethylene/propylene copolymer is measured using a Fourier Transform Infrared method (FTIR) which is correlated to ethylene values determined using ¹³C NMR, as the primary method. The relationship and agreement between measurements conducted using the two methods is described in, e.g., J. R. Paxson, J. C. Randall, “Quantitative Measurement of Ethylene Incorporation into Propylene Copolymers by Carbon-13 Nuclear Magnetic Resonance and Infrared Spectroscopy”, Analytical Chemistry, Vol. 50, No. 13, November 1978, 1777-1780.

The MFR of the second phase was calculated using the equation below

$$Log {MFR}_{P 2} = \frac{Log {MFR}_{C} - f 1 * Log {MFR}_{P 1}}{1 - f 1}$$

Where MFR_{P2} refers to the MFR of the ethylene/propylene copolymer made in the second phase), MFR_{c} refers to the MFR of the composition measured without before it is pelletized (poweder MFR), MFR_{P1} refers to the MFR of the first phase and f₁ refers to the amount of phase 1 in the composition.

Flexural modulus is determined in accordance with ASTM D790-10 Method A at 1.3 mm/min, using a Type 1 specimen per ASTM 3641 and molded according to ASTM D4101.

IZOD impact strength is measured in accordance with ASTM D 256 on specimens molded according to ASTM D4101.

Gardner Impact Testing is measured in accordance with ASTM D5420.

Haze is measured in accordance with ASTM Test D1003 Procedure A using BYK Gardner Haze-Gard Plus 4725 on a 1 mm thick injection molded specimen.

### Polypropylene Polymer Compositions

The present disclosure is related to polypropylene polymer compositions having an improved balance of properties, such as high transparency in combination with excellent impact resistance strength and optionally, excellent stiffness properties. These polypropylene polymer compositions also have low melt flow rates (e.g., 5 g/10 min or less or 4 g/10 min or less). Such polypropylene polymer compositions described herein comprise a heterophasic polypropylene copolymer, which are prepared by combining a first polymer phase comprising polypropylene homopolymer or random copolymer combined with a second polymer phase comprising rubber-like propylene/ethylene copolymer. The selection of specific parameters for each polymer phase as described herein provides the polypropylene polymer composition with high transparency in combination with excellent impact resistance strength (in particular, at room temperature), and optionally excellent stiffness properties. Specifically, the polypropylene polymer compositions described herein have a low haze of less than about 20%, an IZOD impact strength at 23° C. of greater than about 200 J/m, and a flexural modulus of at least about 800 MPa.

This disclosure recognizes that in order to achieve polypropylene polymer compositions having low melt flow rates that have high transparency in combination with excellent impact resistance strength, and optionally excellent stiffness properties require the specific combination of parameters described for the first and second polymer phases. In particular, low to none one or more comonomer content (e.g., ethylene content) in the first polymer phase and low ethylene content in the second polymer phase (less than 18% by weight) provides high stiffness/toughness and high clarity. Such parameters provide a polypropylene composition having a low ethylene content (e.g., less than about 5% by weight).

The polypropylene compositions described herein may high have clarity and high toughness. Provided in one aspect is a polypropylene composition comprising:
(a) a first polymer phase comprising a polypropylene homopolymer or random copolymer comprising optionally one or more comonomers in an amount of equal or less than about 3% by weight, based upon the total weight of the propylene homopolymer or copolymer, having a total cold xylene solubles content of from about 2% by weight to about 6% by weight, and having a melt flow rate of about 0.5 g/10 min to about 3 g/10 min; and
(b) a second polymer phase comprising a propylene/ethylene copolymer comprising ethylene in an amount of less than about 18% by weight, based upon the total weight of the propylene/ethylene copolymer;
   wherein the ratio of the melt flow rate of the polypropylene homopolymer or random copolymer to the melt flow rate of the propylene/ethylene copolymer is greater than about 1.0; and
   wherein the first polymer phase and the second polymer phase are combined to provide the polypropylene composition having a melt flow rate of about 4 g/10 min or less, an ethylene content of less than about 5% by weight, a total cold xylene solubles content of from about 5% by weight to about 20% by weight, a haze at 1 mm of less than about 20%, an IZOD impact strength at 23° C. of greater than about 500 J/m, a Gardner drop impact strength at 0° C. of greater than about 150 inch-lbs, and a flexural modulus of greater than or equal about 800 MPa.

In any embodiment, the first polymer phase comprises a crystalline matrix comprising the polypropylene homopolymer or random copolymer. In any embodiment, the polypropylene composition comprises a heterophasic propylene copolymer. In some embodiments, butene may also be present in the second polymer phase. In some embodiments, the propylene/ethylene copolymer present in the second polymer phase comprises butene.

The first polymer phase comprising a polypropylene homopolymer or random copolymer may comprise optionally one or more comonomers in an amount of equal or less than about 3% by weight, based upon the total weight of the propylene homopolymer or copolymer. In some embodiments, the first polymer phase comprises the polypropylene homopolymer or random copolymer comprising one or more comonomers in an amount of from about 0% by weight to about 3% by weight, based upon the total weight of the propylene homopolymer or copolymer, including about 0% by weight, about 0.5% by weight, about 1.0% by weight, about 1.5% by weight, about 2.0% by weight, about 2.5% by weight, and about 3.0% by weight.

The first polymer phase comprising a polypropylene homopolymer or random copolymer may have a total cold xylene solubles content of from about 2% by weight to about 6% by weight, including about 2.1% by weight, about 2.2% by weight, about 2.3% by weight, about 2.4% by weight, about 2.5% by weight, about 2.6% by weight, about 2.7% by weight, about 2.8% by weight, about 2.9% by weight, about 3.0% by weight, about 3.1% by weight, about 3.2% by weight, about 3.3% by weight, about 3.4% by weight, about 3.5% by weight, about 3.6% by weight, about 3.7% by weight, about 3.8% by weight, about 3.9% by weight, about 4.0% by weight, 4.1% by weight, about 4.2% by weight, about 4.3% by weight, about 4.4% by weight, about 4.5% by weight, about 4.6% by weight, about 4.7% by weight, about 4.8% by weight, about 4.9% by weight, about 5.0% by weight, 5.1% by weight, about 5.2% by weight, about 5.3% by weight, about 5.4% by weight, about 5.5% by weight, about 5.6% by weight, about 5.7% by weight, about 5.8% by weight, about 5.9% by weight, and about 6.0% by weight. In some embodiments, the first polymer phase comprises the polypropylene homopolymer or random copolymer having a total cold xylene solubles content of about 2.5% by weight or about 4.8% by weight.

The first polymer phase comprising a polypropylene homopolymer or random copolymer may have a melt flow rate of about 0.5 g/10 min to about 3 g/10 min, including about 0.5 g/10 min, about 0.6 g/10 min, about 0.7 g/10 min, about 0.8 g/10 min, about 0.9 g/10 min, about 1.0 g/10 min, about 1.1 g/10 min, about 1.2 g/10 min, about 1.3 g/10 min, about 1.4 g/10 min, about 1.5 g/10 min, about 1.6 g/10 min, about 1.7 g/10 min, about 1.8 g/10 min, about 1.9 g/10 min, about 2.0 g/10 min, about 2.1 g/10 min, about 2.2 g/10 min, about 2.3 g/10 min, about 2.4 g/10 min, about 2.5 g/10 min, about 2.6 g/10 min, about 2.7 g/10 min, about 2.8 g/10 min, about 2.9 g/10 min, and about 3.0 g/10 min. In some embodiments, the first polymer phase comprises the polypropylene homopolymer or random copolymer having a melt flow rate of from about 0.5 g/10 min to about 1.5 g/10 min. In some embodiments, the first polymer phase comprises the polypropylene homopolymer or random copolymer having a melt flow rate of about 0.9 g/10 min.

The polypropylene composition may have a melt flow rate of 4 g/10 min or less, including about 0.5 g/10 min, about 1 g/10 min, about 1.5 g/10 min, about 2 g/10 min, about 2.5 g/10 min, about 3 g/10 min, about 3.5 g/10 min, and about 4 g/10 min. In some embodiments, the polypropylene composition has a melt flow rate of from about 0.5 g/10 min to about 1.5 g/10 min.

The polypropylene composition may have an ethylene content of less than 5% by weight, including about 0.5% by weight, about 1% by weight, about 1.5% by weight, about 2% by weight, about 2.5% by weight, about 3% by weight, about 3.5% by weight, about 4% by weight, about 4.5% by weight, and about 5% by weight. In some embodiments, the polypropylene composition has an ethylene content of from about 2% by weight to about 4.5% by weight.

The polypropylene composition may have a total cold xylene solubles content of from about 5% by weight to about 20% by weight, including about 5% by weight, about 6% by weight, about 7% by weight, about 8% by weight, about 9% by weight, about 10% by weight, about 11% by weight, about 12% by weight, about 13% by weight, about 14% by weight, about 15% by weight, about 16% by weight, about 17% by weight, about 18% by weight, about 19% by weight, and about 20% by weight. In some embodiments, the polypropylene composition has a total cold xylene solubles content of about 7% by weight or about 12% by weight.

The polypropylene composition may have a haze at 1 mm of less than about 20%, including about V %, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, and about 20%. In some embodiments, the polypropylene composition has a haze at 1 mm of from about 5% to about 15%.

The polypropylene composition may have an IZOD impact strength at 23° C. of greater than about 500 J/m, including about 500 J/m, about 525 J/m, about 575 J/m, about 600 J/m, about 625 J/m, about 650 J/m, about 675 J/m, about 700 J/m, about 725 J/m, about 750 J/m, about 775 J/m, about 800 J/m, about 825 J/m, about 850 J/m, about 875 J/m, and about 900 J/m. In some embodiments, the polypropylene composition has an IZOD impact strength at 23° C. of from about 500 J/m to about 900 J/m.

The polypropylene composition may have a Gardner drop impact strength at 0° C. of greater than about 150 inch-lbs, including about 150 inch-lbs, about 175 inch-lbs, about 200 inch-lbs, about 225 inch-lbs, about 250 inch-lbs, about 275 inch-lbs, about 300 inch-lbs, about 325 inch-lbs, and about 350 inch-lbs. In some embodiments, the polypropylene composition has a Gardner drop impact strength at 0° C. of from about 150 inch-lbs to about 350 inch-lbs.

The polypropylene composition may have a flexural modulus of greater than or equal about 800 MPa, including about 800 MPa, about 825 MPa, about 850 MPa, about 870 MPa, about 900 MPa, about 925 MPa, about 950 MPa, about 975 MPa, about 1000 MPa, about 1025 MPa, about 1050 MPa, about 1075 MPa, about 1100 MPa, about 1125 MPa, about 1150 MPa, about 1175 MPa, about 1200 MPa, about 1225 MPa, about 1250 MPa, about 1275 MPa, and about 1300 MPa. In some embodiments, the polypropylene composition has a flexural modulus of from about 800 MPa to about 1300 MPa.

The polypropylene compositions described herein may have high clarity, high toughness, and high stiffness. Provided in another aspect is a polypropylene composition comprising:
(a) a first polymer phase comprising a polypropylene homopolymer or random copolymer comprising optionally one or more comonomers in an amount of equal or less than about 1% by weight, based upon the total weight of the propylene homopolymer or copolymer, having a total cold xylene solubles content of less than about 4% by weight, and having a melt flow rate of from about 2 g/10 min to about 5 g/10 min; and
(b) a second polymer phase comprising a propylene/ethylene copolymer comprising ethylene in an amount of less than about 18% by weight, based upon the total weight of the propylene/ethylene copolymer:
   wherein the ratio of the melt flow rate of the polypropylene homopolymer or random copolymer to the melt flow rate of the propylene/ethylene copolymer is greater than about 1.0; and
   wherein the first polymer phase and the second polymer phase are combined to provide the polypropylene composition having a melt flow rate of about 5 g/10 min or less, an ethylene content of less than about 3.5% by weight, a total cold xylene solubles content of from about 5% by weight to about 15% by weight, a haze at 1 mm of less than about 20%, an IZOD impact strength at 23° C. of greater than about 200 J/m, and a flexural modulus of greater than or equal about 1100 MPa.

The first polymer phase comprising a polypropylene homopolymer or random copolymer may comprise optionally one or more comonomers in an amount of equal or less than about 1% by weight, based upon the total weight of the propylene homopolymer or copolymer, including about 0.1% by weight, about 0.2% by weight, about 0.3% by weight, about 0.4% by weight, about 0.5% by weight, about 0.6% by weight, about 0.7% by weight, about 0.8% by weight, about 0.9% by weight, and about 1% by weight. In some embodiments, the first polymer phase comprises the polypropylene homopolymer or random copolymer comprising one or more comonomers in an amount of from about 0.5% by weight to about 1% by weight, based upon the total weight of the propylene homopolymer or copolymer.

The first polymer phase comprising a polypropylene homopolymer or random copolymer may have a total cold xylene solubles content of less than about 4% by weight, including about 0.5% by weight, about 1% by weight, about 1.5% by weight, about 2% by weight, about 2.5% by weight, about 3% by weight, about 3.5% by weight, and about 4% by weight. In some embodiments, the first polymer phase comprises the polypropylene homopolymer or random copolymer having a total cold xylene solubles content of from about 1% by weight to about 3% by weight.

The first polymer phase comprising a polypropylene homopolymer or random copolymer may have a melt flow rate of from about 2 g/10 min to about 5 g/10 min, including about 2 g/10 min, about 2.5 g/10 min, about 3 g/10 min, about 3.5 g/10 min, about 4 g/10 min, about 4.5 g/10 min, and about 5 g/10 min. In some embodiments, the first polymer phase comprises the polypropylene homopolymer or random copolymer having a melt flow rate of from about 2 g/10 min to about 4 g/10 min.

The polypropylene composition may have a melt flow rate of about 5 g/10 min or less, including about 0.5 g/10 min, about 1 g/10 min, about 1.5 g/10 min, about 2 g/10 min, about 2.5 g/10 min, about 3 g/10 min, about 3.5 g/10 min, about 4 g/10 min, about 4.5 g/10 min, and about 5 g/10 min. In some embodiments, the polypropylene composition has a melt flow rate of from about 2 g/10 min to about 4 g/10 min.

The polypropylene composition may have an ethylene content of less than about 3.5% by weight, including about 0.5% by weight, about 1% by weight, about 1.5% by weight, about 2% by weight, about 2.5% by weight, about 3% by weight, and about 3.5% by weight. In some embodiments, the polypropylene composition has an ethylene content of from about 2% by weight to about 3.5% by weight.

The polypropylene composition may have a total cold xylene solubles content of from about 5% by weight to about 15% by weight, including about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, about 10% by weight, about 10.5% by weight, about 11% by weight, about 11.5% by weight, about 12% by weight, about 12.5% by weight, about 13% by weight, about 13.5% by weight, about 14% by weight, about 14.5% by weight, and about 15% by weight. In some embodiments, the polypropylene composition has a total cold xylene solubles content of from about 5.5% by weight or about 12% by weight.

The polypropylene composition may have a haze at 1 mm of less than about 20%, including about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, and about 20%. In some embodiments, the polypropylene composition has a haze at 1 mm of from about 10% to about 20%.

The polypropylene composition may an IZOD impact strength at 23° C. of greater than about 200 J/m, including about 200 J/m, about 225 J/m, about 250 J/m, about 275 J/m, about 300 J/m, about 325 J/m, about 375 J/m, about 400 J/m, about 425 J/m, about 450 J/m, about 475 J/m, about 500 J/m, about 525 J/m, about 550 J/m, about 575 J/m, about 600 J/m, about 625 J/m, about 650 J/m, about 675 J/m, about 700 J/m, about 725 J/m, about 750 J/m, about 775 J/m, about 800 J/m, about 825 J/m, about 850 J/m, about 875 J/m, and about 900 J/m. In some embodiments, the polypropylene composition has an IZOD impact strength at 23° C. of from about 200 J/m to about 900 J/m. In some embodiments, the polypropylene composition has an IZOD impact strength at 23° C. of from about 200 J/m to about 600 J/m.

The polypropylene composition may a flexural modulus of greater than or equal about 1200 MPa, including about 1200 MPa, about 1225 MPa, about 1250 MPa, about 1275 MPa, about 1300 MPa, about 1325 MPa, about 1350 MPa, about 1375 MPa, about 1400 MPa, about 1425 MPa, about 1450 MPa, about 1475 MPa, about 1500 MPa, about 1525 MPa, about 1550 MPa, about 1575 MPa, and about 1600 MPa. In some embodiments, the polypropylene composition has a flexural modulus of from about 1200 MPa to about 1500 MPa. In some embodiments, the polypropylene composition has a flexural modulus of from about 1200 MPa to about 1600 MPa.

The second polymer phase may comprise a propylene/ethylene copolymer comprising ethylene in an amount of less than about 18% by weight, based upon the total weight of the propylene/ethylene copolymer, including about 1% by weight, about 2% by weight, about 3% by weight, about 4% by weight, about 5% by weight, about 6% by weight, about 7% by weight, about 8% by weight, about 9% by weight, about 10% by weight, about 11% by weight, about 12% by weight, about 13% by weight, about 14% by weight, about 15% by weight, about 16% by weight, about 17% by weight, and about 18% by weight. In any embodiment, the second polymer phase comprises a propylene/ethylene copolymer comprising ethylene in an amount of from about 10% by weight to about 18% by weight, based upon the total weight of the propylene/ethylene copolymer.

The ratio of the melt flow rate of the polypropylene homopolymer or random copolymer to the melt flow rate of the propylene/ethylene copolymer may be greater than about 1.0, including about 1.0, about 1.5, about 2.0, about 2.5, and about 3.0. In any embodiment, the ratio of the melt flow rate of the polypropylene homopolymer or random copolymer to the melt flow rate of the propylene/ethylene copolymer is from about 1.0 to about 3.0.

In any embodiment, the polypropylene composition has a Gardner drop impact strength at 23° C. of greater than about 150 inch-lbs, including about 150 inch-lbs, about 175 inch-lbs, about 200 inch-lbs, about 225 inch-lbs, about 250 inch-lbs, about 275 inch-lbs, about 300 inch-lbs, about 325 inch-lbs, and about 350 inch-lbs.

In any embodiment, the one or more comonomers present in the polypropylene homopolymer or random copolymer are ethylene, butene, 1-hexene, and 1-octene. In some embodiments, the one or more comonomers present in the polypropylene homopolymer or random copolymer is ethylene.

The polypropylene composition of the present disclosure may contain various other additives and ingredients. For instance, the polypropylene composition can contain nucleators, mold release agents, slip agents, antiblocks, UV stabilizers, heat stabilizer, colorants/tints, and the like. In one embodiment, the polymer composition can contain an antioxidant, such as a hindered phenolic antioxidant. The polymer composition can also contain an antacid. For instance, the polymer composition can contain an antacid and an antioxidant. The polymer composition can also contain an acid scavenger. Each of the additives can be present in the polymer composition generally in an amount less than about 3% by weight, such as in an amount less than about 2% by weight, such as in an amount less than about 1% by weight, such as in an amount less than about 0.5% by weight, and generally in an amount greater than about 0.001% by weight. In any embodiment, the polypropylene composition further comprises one or more of a nucleator, an antacid, and an antioxidant.

In one embodiment, the polypropylene composition can further contain a nucleator. The nucleator can be added to further improve the transparency properties of the composition. The nucleator, for instance, can comprise a compound capable of producing a gelation network within the composition.

In one embodiment, the nucleator may comprise a sorbitol compound, such as a sorbitol acetal derivative. In one embodiment, for instance, the nucleator may comprise a dibenzyl sorbitol.

With regard to sorbitol acetal derivatives that can be used as an additive in some embodiments, the sorbitol acetal derivative is shown in Formula (I):

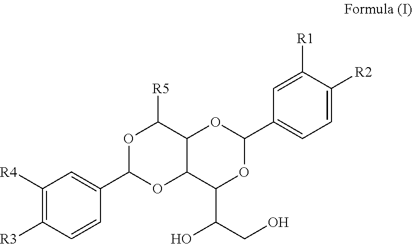

wherein R1-R5 comprise the same or different moieties chosen from hydrogen and a C1-C3 alkyl.

In some embodiments, R1-R5 are hydrogen, such that the sorbitol acetal derivative is 2,4-dibenzylidene sorbitol (“DBS”). In some embodiments, R1, R4, and R5 are hydrogen, and R2 and R3 are methyl groups, such that the sorbitol acetal derivative is 1,3:2,4-di-p-methyldibenzylidene-D-sorbitol (“MDBS”). In some embodiments, R1-R4 are methyl groups and R5 is hydrogen, such that the sorbitol acetal derivative is 1,3:2,4-Bis (3,4-dimethylobenzylideno) sorbitol (“DMDBS”). In some embodiments, R2, R3, and R5 are propyl groups (—CH2-CH2-CH3), and R1 and R4 are hydrogen, such that the sorbitol acetal derivative is 1,2,3-trideoxy-4,6:5,7-bis-O-(4-propylphenyl methylene) nonitol (“TBPMN”).

Other embodiments of nucleators that may be used include 1,3:2,4-dibenzylidenesorbitol, 1,3:2,4-bis(p-methylbenzylidene)sorbitol, Di(p-methylbenzylidene)Sorbitol, Di(p-ethylbenzylidene)Sorbitol, Bis(5′,6′,7′,8′-tetrahydro-2-naphtylidene)Sorbitol.

In one embodiment, the nucleator may also comprise a bisamide, such as benzenetrisamide. The nucleators described above can be used alone or in combination.

When present in the polymer composition, one or more nucleators are generally added in an amount greater than about 200 ppm, such as in an amount greater than about 1,800 ppm, such as in an amount greater than about 2,000 ppm, such as in an amount greater than about 2,200 ppm. One or more nucleators are generally present in an amount less than about 8,000 ppm, such as less than about 6,000 ppm, such as less than about 5,000 ppm. The amount of nucleator present in the composition can depend upon various factors including the type of nucleator that is used. In some embodiments, the one or more nucleators are present in an amount of about 5000 ppm or lower.

The first phase polymer and the second phase polymer may be produced using various different polymerization methods and procedures. In one embodiment, a Ziegler-Natta catalyst is used to produce both polymers. For example, the olefin polymerization may occur in the presence of a catalyst system that includes a catalyst, an internal electron donor, a cocatalyst, and optionally an external electron donor. Olefins of the formula CH₂═CHR, where R is hydrogen or a hydrocarbon radical with 1 to 12 atoms, may be contacted with the catalyst system under suitable conditions to form the polymer products. Copolymerization may occur in a method-step process in order to generate the heterophasic composition of the present disclosure. The polymerization process may be carried out using known techniques in the gas phase using fluidized bed or stir bed reactors or in a slurry phase using an inert hydrocarbon solvent or diluent or liquid monomer.

In one embodiment, the first phase polymer and the second phase polymer may be produced in a two-stage process that includes a first stage, in which the propylene random copolymer of the continuous polymer phase is prepared, and a second stage, in which the ethylene-propylene copolymer is produced. The first stage polymerization may be carried out in one or more bulk reactors or in one or more gas phase reactors. The second stage polymerization may be carried out in one or more gas phase reactors. The second stage polymerization is typically carried out directly following the first stage polymerization. For example the polymerization product recovered from the first polymerization stage can be conveyed directly to the second polymerization stage. A heterophasic copolymer composition is produced.

Also provided in another aspect is a process for preparing any one of the polypropylene compositions described herein by sequential polymerization in the presence of a Ziegler-Natta catalyst, wherein:
preparing a first polymer phase in first gas phase reactor, and
transferring the first polymer phase to a second gas phase reactor comprising a second polymer phase;
wherein combining the first polymer phase with the second polymer phase provides the polypropylene composition.

Also provided in another aspect is a process for preparing any one of the polypropylene composition described herein comprising:
feeding propylene and optionally one or more comonomers into a first reactor; feeding into the first reactor a catalyst mixture comprising (1) a Ziegler-Natta catalyst, (2) a cocatalyst, and (3) an external donor;
contacting the propylene with the catalyst mixture under first polymerization conditions to polymerize propylene and optionally one or more comonomers to form a first polymer phase comprising a propylene homopolymer or copolymer;
transferring at least a portion of the first polymer phase to a second reactor; and
feeding additional propylene and ethylene into the second reactor to form a second polymer phase;
   wherein combining the first polymer phase with the second polymer phase provides the polypropylene composition. In some embodiments, the second polymer phase may further comprise butene. In some embodiments, feeding additional propylene and ethylene into the second reaction also comprises feeding butene to form a second polymer phase.

In one embodiment of the present disclosure, the polymerizations are carried out in the presence of a stereoregular olefin polymerization catalyst.

In one embodiment, the catalyst includes a procatalyst composition that contains a titanium moiety such as titanium chloride, a magnesium moiety such as magnesium chloride, and at least one internal electron donor.

The procatalyst precursor may include (i) magnesium, (ii) a transition metal compound from Periodic Table groups IV-VII, (iii) a halide, an oxylahilde, and or an alkoxide, and/or an alkoxide of (i) or (i) and/or (ii), and (iv) combination of (i), (ii), and (iii). Non limiting examples of suitable procatalyst precursors include halides, oxyhalides, alkoxides of magnesium, manganese, titanium, vanadium, chromium, molybdenum, zirconium, hafnium, and combinations thereof.

In an embodiment, the procatalyst precursor contains magnesium as the sole metal component. Non limiting examples include anhydrous magnesium chloride and/or its alcohol adduct, magnesium alkoxide, and or aryloxide, mixed magnesium alkoxy halide, and/or carboxylated magnesium dialkoxide or aryloxide.

In an embodiment, the procatalyst precursor is an alcohol adduct of anhydrous magnesium chloride. The anhydrous magnesium chloride adduct is generally defined as MgCl₂-nROH where n has a range of 1.5-6.0, preferably 2.5-4.0, and most preferably 2.8-3.5 moles total alcohol. ROH is a C₁-C₄ alcohol, linear or branched, or mixture of alcohol. Preferably ROH is ethanol or a mixture of ethanol and a higher alcohol. If ROH is a mixture, the mole ratio of ethanol to higher alcohol is at least 80:20, preferably 90:10, and most preferably at least 95:5.

In one embodiment, a substantially spherical MgCl₂-nEtOH adduct may be formed by a spray crystallization process. In one, embodiment the spherical MgCl₂ precursor has an average particle size (Malvern d₅₀) of between about 15-150 microns, preferably between 20-100 microns, and most preferably between 35-85 microns.

In one embodiment, the procatalyst precursor contains a transition metal compound and a magnesium metal compound. The transition metal compound has the general formula TrXₓ, where Tr is the transition metal, X is a halogen or a C₁₋₁₀ hydrocarboxyl or hydrocarbyl group, and x is the number of such X groups in the compound in combination with a magnesium metal compound. Tr may be a Group IV, V or VI metal. In one embodiment, Tr is a Group IV metal, such as titanium. X may be chloride, bromide, C₁₋₄ alkoxide or phenoxide, or a mixture thereof. In one embodiment, X is chloride.

The precursor composition may be prepared by the chlorination of the foregoing mixed magnesium compounds, titanium compounds, or mixtures thereof.

In one embodiment, the precursor composition is a mixed magnesium/titanium compound of the formula Mg_{d}Ti(OR^{e})_{f}X_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine; d is 0.5 to 56; or 2-4, or 3; f is 2 to 116, or 5 to 15; and g is 0.5 to 116, or 1 to 3.

In accordance with the present disclosure, the above described procatalyst precursor is combined with at least one internal electron donor. The internal electron donor may comprise a substituted phenylene aromatic diester.

In one embodiment, the first internal electron donor comprises a substituted phenylene aromatic diester having the following structure (I):

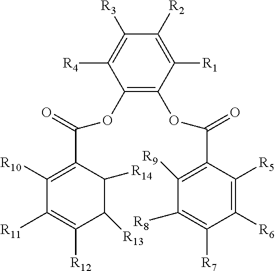

wherein R₁-R₁₄ are the same or different. Each of R₁-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. At least one R₁-R₁₄ is not hydrogen.

In one embodiment, the substituted phenylene aromatic diester may be any substituted phenylene aromatic diester as disclosed in U.S. Patent Application Ser. No. 61/141,959 filed on Dec. 31, 2008, the entire content of which is incorporated by reference herein.

In one embodiment, the substituted phenylene aromatic diester may be any substituted phenylene aromatic diester disclosed in WO12088028, filed on Dec. 20, 2011, the entire content of which is incorporated by reference herein.

In one embodiment, at least one (or two, or three, or four) R group(s) of R₁-R₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, at least one (or some, or all) R group(s) of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₅-R₉ and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, at least one of R₁-R₄ and at least one of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₁-R₄, at least one of R₅-R₉ and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, any consecutive R groups in R₁-R₄, and/or any consecutive R groups in R₅-R₉, and/or any consecutive R groups in R₁₀-R₁₄ may be linked to form an inter-cyclic or an intra-cyclic structure. The inter-/intra-cyclic structure may or may not be aromatic. In one embodiment, the inter-/intra-cyclic structure is a C₅ or a C₆ membered ring.

In one embodiment, at least one of R₁-R₄ is selected from a substituted hydrocarbyl group having 1 to 20 carbon atoms, an unsubstituted hydrocarbyl group having 1 to 20 carbon atoms, and combinations thereof. Optionally, at least one of R₅-R₁₄ may be a halogen atom or an alkoxy group having 1 to 20 carbon atoms. Optionally, R₁-R₄, and/or R₅-R₉, and/or R₁₀-R₁₄ may be linked to form an inter-cyclic structure or an intra-cyclic structure. The inter-cyclic structure and/or the intra-cyclic structure may or may not be aromatic.

In one embodiment, any consecutive R groups in R₁-R₄, and/or in R₅-R₉, and/or in R₁₀-R₁₄, may be members of a C₅-C₆-membered ring.

In one embodiment, structure (I) includes R₁, R₃ and R₄ as hydrogen. R₂ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, R₂ is selected from a C₁-C₅ alkyl group, a C₃-C₆ cycloalkyl, or a substituted C₃-C₆ cycloalkyl group. R₂ can be a methyl group, an ethyl group, a n-propyl group, an isopropyl group, a t-butyl group, an isobutyl group, a sec-butyl group, a 2,4,4-trimethylpentan-2-yl group, a cyclopentyl group, and a cyclohexyl group.

In one embodiment, structure (I) includes R₂ that is methyl, and each of R₅-R₁₄ is hydrogen.

In one embodiment, structure (I) includes R₂ that is ethyl, and each of R₅-R₁₄ is hydrogen.

In one embodiment, structure (I) includes R₂ that is t-butyl, and each of R₅-R₁₄ is hydrogen.

In one embodiment, structure (I) includes R₂ that is ethoxycarbonyl, and each of R₅-R₁₄ is hydrogen.

In one embodiment, structure (I) includes R₂, R₃ and R₄ each as hydrogen and R₁ is selected from a substituted hydrocarbyl group having 1 to 20 carbon atoms, an unsubstituted hydrocarbyl group having 1 to 20 carbon atoms, and combinations thereof. R₅-R₁₄ are the same or different and each is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, structure (I) includes R₁ that is methyl, and each of R₅-R₁₄ is hydrogen.

In one embodiment, structure (I) includes R₂ and R₄ that are hydrogen and R₁ and R₃ are the same or different. Each of R₁ and R₃ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, structure (I) includes R₁ and R₃ that are the same or different. Each of R₁ and R₃ is selected from a C₁-C₈ alkyl group, a C₃-C₆ cycloalkyl group, or a substituted C₃-C₆ cycloalkyl group. R₅-R₁₄ are the same or different and each of R₅-R₁₄ is selected from hydrogen, a C₁-C₈ alkyl group, and a halogen. Nonlimiting examples of suitable C₁-C₈ alkyl groups include methyl, ethyl, n-propyl, isopropyl, n-butyl, i-butyl, t-butyl, n-pentyl, i-pentyl, neopentyl, t-pentyl, n-hexyl, and 2,4,4-trimethylpentan-2-yl group. Nonlimiting examples of suitable C₃-C₆ cycloalkyl groups include cyclopentyl and cyclohexyl groups. In a further embodiment, at least one of R₅-R₁₄ is a C₁-C₅ alkyl group or a halogen.

In one embodiment, structure (I) includes R₁ that is a methyl group and R₃ that is a t-butyl group. Each of R₂, R₄ and R₅-R₁₄ is hydrogen.

In one embodiment, structure (I) includes R₁ and R₃ that is an isopropyl group. Each of R₂, R₄ and R₅-R₁₄ is hydrogen.

In one embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In one embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In one embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In one embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In one embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₅, R₁₁, and R₁₃ is hydrogen.

In one embodiment, the substituted phenylene aromatic diester has a structure (II) which includes R₁ that is a methyl group and R₃ is a t-butyl group. Each of R₂ and R₄ is hydrogen. R₈ and R₉ are members of a C₆ membered ring to form a 1-naphthoyl moiety. R₁₃ and R₁₄ are members of a C₆ membered ring to form another 1-naphthoyl moiety. Structure (II) is provided below.

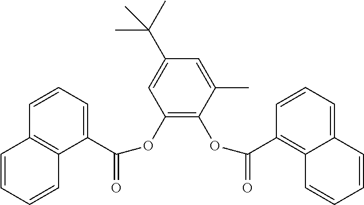 [SMILES: Cc1cc(C(C)(C)C)cc(OC(=O)c2cccc3ccccc23)c1OC(=O)c1cccc2ccccc12]

In one embodiment, the substituted phenylene aromatic diester has a structure (III) which includes R₁ that is a methyl group and R₃ is a t-butyl group. Each of R₂ and R₄ is hydrogen. R₆ and R₇ are members of a C₆ membered ring to form a 2-naphthoyl moiety. R₁₂ and R₁₃ are members of a C₆ membered ring to form a 2-naphthoyl moiety. Structure (III) is provided below.

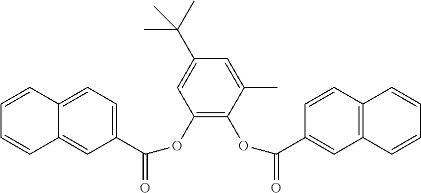 [SMILES: Cc1cc(C(C)(C)C)cc(OC(=O)c2ccc3ccccc3c2)c1OC(=O)c1ccc2ccccc2c1]

In one embodiment, structure (I) includes R₁ that is a methyl group and R₃ is a t-butyl group. Each of R₇ and R₁₂ is an ethoxy group. Each of R₂, R₄, R₅, R₆, R₅, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is a chlorine atom. Each of R₂, R₄, R₅, R₆, R₅, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is a bromine atom. Each of R₂, R₄, R₅, R₆, R₅, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is an iodine atom. Each of R₂, R₄, R₅, R₆, R8, R₉, R₁₀, R₁₁, R₁₃, and R₁₄ is hydrogen.

In one embodiment, structure (I) includes R₁ that is a methyl group and R₃ is a t-butyl group. Each of R₆, R₇, R₁₁, and R₁₂ is a chlorine atom. Each of R₂, R₄, R₅, R₅, R₉, R₁₀, R₁₃, and R₁₄ is hydrogen.

In one embodiment, structure (I) includes R₁ that is a methyl group and R₃ is a t-butyl group. Each of R₆, R₅, R₁₁, and R₁₃ is a chlorine atom. Each of R₂, R₄, R₅, R₇, R₉, R₁₀, R₁₂, and R₁₄ is hydrogen.

In one embodiment, structure (I) includes R₁ that is a methyl group and R₃ is a t-butyl group. Each of R₂, R₄ and R₅-R₁₄ is a fluorine atom.

In one embodiment, structure (I) includes R₁ that is a methyl group and R₃ is a t-butyl group. Each of R₇ and R₁₂ is a trifluoromethyl group. Each of R₂, R₄, R₅, R₆, R₅, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is an ethoxycarbonyl group. Each of R₂, R₄, R₅, R₆, R₅, R₉, R₁₀, R₁₁, R₁₃ and R₁₄ is hydrogen.

In one embodiment, R₁ is a methyl group and R₃ is a t-butyl group. Each of R₇ and R₁₂ is an ethoxy group. Each of R₂, R₄, R₅, R₆, R₅, R₉, R₁₀, R₁₁, R₁₃, and R₁₄ is hydrogen.

In one embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In one embodiment, structure (I) includes R₁ that is a methyl group and R₃ is a 2,4,4-trimethylpentan-2-yl group. Each of R₂, R₄ and R₅-R₁₄ is hydrogen.

In one embodiment, structure (I) includes R₁ and R₃, each of which is a sec-butyl group. Each of R₂, R₄ and R₅-R₁₄ is hydrogen.

In one embodiment, the substituted phenylene aromatic diester has a structure (IV) whereby R₁ and R₂ are members of a C₆ membered ring to form a 1,2-naphthalene moiety. Each of R₅-R₁₄ is hydrogen. Structure (IV) is provided below.

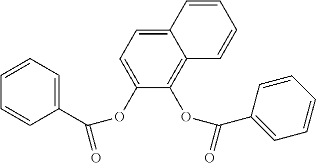 [SMILES: O=C(Oc1ccc2ccccc2c1OC(=O)c1ccccc1)c1ccccc1]

In one embodiment, the substituted phenylene aromatic diester has a structure (V) whereby R₂ and R₃ are members of a C₆ membered ring to form a 2,3-naphthalene moiety. Each of R₅-R₁₄ is hydrogen. Structure (V) is provided below.

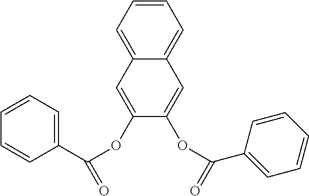 [SMILES: O=C(Oc1cc2ccccc2cc1OC(=O)c1ccccc1)c1ccccc1]

In one embodiment, structure (I) includes R₁ and R₄ that are each a methyl group. Each of R₂, R₃, R₅-R₉ and R₁₀-R₁₄ is hydrogen.

In one embodiment, structure (I) includes R₁ that is a methyl group. R₄ is an i-propyl group. Each of R₂, R₃, R₅-R₉ and R₁₀-R₁₄ is hydrogen.

In one embodiment, structure (I) includes R₁, R₃, and R₄, each of which is an i-propyl group. Each of R₂, R₅-R₉ and R₁₀-R₁₄ is hydrogen.

In one embodiment, each of R₁ and R₄ is selected from a methyl group, an ethyl group, and a vinyl group. Each of R₂ and R₃ is selected from hydrogen, a secondary alkyl group, or a tertiary alkyl group, with R₂ and R₃ not concurrently being hydrogen. Stated differently, when R2 is hydrogen, R3 is not hydrogen (and vice versa).

In one embodiment, a second internal electron donor may be used that generally comprises a polyether that can coordinate in bidentate fashion. In one embodiment the second internal electron donor is a substituted 1,3-diether of structure VI:

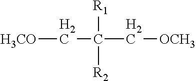

where R₁ and R₂ are the same or different, methyl, C₂-C₁₈ linear or branched alkyls, C₃-C₁₈ cycloalkyl, C₄-C₁₈ cycloalkyl-alkyl, C₄-C₁₈ alkyl-cycloalkyl, phenyl, organosilicon, C₇-C₁₈ arylalkyl, or C₇-C₁₈ alkylaryl radicals; and R₁ or R₂ may also be a hydrogen atom.

In one embodiment the second internal electron donor may comprise a 1,3-diether with cyclic or polycyclic structure VII:

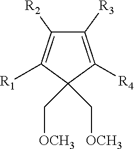

where R₁, R₂, R₃, and R₄ are as described for R₁ and R₂ of structure VI or may be combined to form one or more C₅-C₇ fused aromatic or non-aromatic ring structures, optionally containing an N, O, or S heteroatom. Particular examples of the second internal electron donor include 4,4-bis(methoxymethyl)-2,6-dimethyl heptane, 9,9-bis(methoxymethyl) fluorene, or mixtures thereof.

The precursor is converted to a solid procatalyst by further reaction (halogenation) with an inorganic halide compound, preferably a titanium halide compound, and incorporation of the internal electron donors.

One suitable method for halogenation of the precursor is by reacting the precursor at an elevated temperature with a tetravalent titanium halide, optionally in the presence of a hydrocarbon or halohydrocarbon diluent. The preferred tetravalent titanium halide is titanium tetrachloride.

The resulting procatalyst composition can generally contain titanium in an amount from about 0.5% to about 6% by weight, such as from about 1.5% to about 5% by weight, such as from about 2% to about 4% by weight. The solid catalyst can contain magnesium generally in an amount greater than about 5% by weight, such as in an amount greater than about 8% by weight, such as in an amount greater than about 10% by weight, such as in an amount greater than about 12% by weight, such as in an amount greater than about 14% by weight, such as in an amount greater than about 16% by weight. Magnesium is contained in the catalyst in an amount less than about 25% by weight, such as in an amount less than about 23% by weight, such as in an amount less than about 20% by weight. The internal electron donor can be present in the catalyst composition in an amount less than about 30% by weight, such as in an amount less than about 25% by weight, such as in an amount less than about 22% by weight, such as in an amount less than about 20% by weight, such as in an amount less than about 19% by weight. The internal electron donor is generally present in an amount greater than about 5% by weight, such as in an amount greater than about 9% by weight.

In one embodiment, the procatalyst composition is combined with a cocatalyst to form a catalyst system. A catalyst system is a system that forms an olefin-based polymer when contacted with an olefin under polymerization conditions. The catalyst system may optionally include an external electron donor, an activity limiting agent, and/or various other components.

As used herein, a “cocatalyst” is a substance capable of converting the procatalyst to an active polymerization catalyst. The cocatalyst may include hydrides, alkyls, or aryls of aluminum, lithium, zinc, tin, cadmium, beryllium, magnesium, and combinations thereof. In one embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In one embodiment, preferred cocatalysts are selected from triethylaluminum, triisobutylaluminum, tri-n-hexylaluminum, diisobutylaluminum hydride, and di-n-hexylaluminum hydride, and most preferred cocatalyst is triethylaluminum.

In one embodiment, the cocatalyst is a hydrocarbyl aluminum compound represented by the formula RₙAlX₃₋ₙ wherein n=1 or 2, R is an alkyl, and X is a halide or alkoxide. Nonlimiting examples of suitable compounds are as follows: methylaluminoxane, isobutylaluminoxane, diethylaluminum ethoxide, diisobutylaluminum chloride, tetraethyldialuminoxane, tetraisobutyldialuminoxane, diethylaluminum chloride, ethylaluminum dichloride, methylaluminum dichloride, and dimethylaluminum chloride.

In one embodiment, the catalyst composition includes an external electron donor. As used herein, an “external electron donor” is a compound added independent of procatalyst formation and contains at least one functional group that is capable of donating a pair of electrons to a metal atom. Bounded by no particular theory, it is believed that the external electron donor enhances catalyst stereoselectivity, (i.e., to reduces xylene soluble material in the formant polymer).

In one embodiment, the external electron donor may be selected from one or more of the following: an alkoxysilane, an amine, an ether, a carboxylate, a ketone, an amide, a carbamate, a phosphine, a phosphate, a phosphite, a sulfonate, a sulfone, and/or a sulfoxide.

In one embodiment, the external electron donor is an alkoxysilane. The alkoxysilane has the general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R′ containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2.

Nonlimiting examples of suitable silane compositions include dicyclopentyldimethoxysilane, di-tert-butyldimethoxysilane, methylcyclohexyldimethoxysilane, methylcyclohexyldiethoxysilane, ethylcyclohexyldimethoxysilane, diphenyldimethoxysilane, diisopropyldimethoxysilane, di-n-propyldimethoxysilane, diisobutyldimethoxysilane, diisobutyldiethoxysilane, isobutylisopropyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, diethylaminotriethoxysilane, cyclopentylpyrrolidinodimethoxysilane, bis(pyrrolidino)dimethoxysilane, bis(perhydroisoquinolino)dimethoxysilane, and dimethyldimethoxysilane. In one embodiment, the silane composition is dicyclopentyldimethoxysilane (DCPDMS), methylcyclohexyldimethoxysilane (MChDMS), diisopropyldimethoxysilane (DIPDMS), n-propyltrimethoxysilane (NPTMS), diethylaminotriethoxysilane (DATES), or n-propyltriethoxysilane (PTES), and any combination of thereof.

In one embodiment, the external donor can be a mixture of at least 2 alkoxysilanes. In a further embodiment, the mixture can be dicyclopentyldimethoxysilane and methylcyclohexyldimethoxysilane, dicyclopentyldimethoxysilane and tetraethoxysilane, or dicyclopentyldimethoxysilane and n-propyltriethoxysilane.

In one embodiment, the external electron donor is selected from one or more of the following: a benzoate, and/or a diol ester. In another embodiment, the external electron donor is 2,2,6,6-tetramethylpiperidine. In still another embodiment, the external electron donor is a diether.

In one embodiment, the catalyst composition includes an activity limiting agent (ALA). As used herein, an “activity limiting agent” (“ALA”) is a material that reduces catalyst activity at elevated temperature (i.e., temperature greater than about 85° C.). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester, a diether, a poly(alkene glycol), poly(alkene glycol)ester, a diol ester, and combinations thereof. The carboxylic acid ester can be an aliphatic or aromatic, mono- or poly-carboxylic acid ester. Nonlimiting examples of suitable monocarboxylic acid esters include ethyl and methyl benzoate, ethyl p-methoxybenzoate, methyl p-ethoxybenzoate, ethyl p-ethoxybenzoate, ethyl acrylate, methyl methacrylate, ethyl acetate, ethyl p-chlorobenzoate, hexyl p-aminobenzoate, isopropyl naphthenate, n-amyl toluate, ethyl cyclohexanoate and propyl pivalate.

In one embodiment, the external electron donor and/or activity limiting agent can be added into the reactor separately. In another embodiment, the external electron donor and the activity limiting agent can be mixed together in advance and then added into the reactor as a mixture. In the mixture, more than one external electron donor or more than one activity limiting agent can be used. In one embodiment, the mixture is dicyclopentyldimethoxysilane and isopropyl myristate, dicyclopentyldiniethoxysilane and poly(ethylene glycol) laurate, dicyclopentyldimethoxysilane and isopropyl myristate and poly(ethylene glycol) dioleate, methylcyclohexyldimethoxysilane and isopropyl myristate, n-propyltrimethoxysilane and isopropyl myristate, dimethyldimethoxysilane and methylcyclohexyldimethoxysilane and isopropyl myristate, dicyclopentyldimethoxysilane and n-propyltriethoxysilane and isopropyl myristate, and dicyclopentyldimethoxysilane and tetraethoxysilane and isopropyl myristate, and combinations thereof.

In one embodiment, the catalyst composition includes any of the foregoing external electron donors in combination with any of the foregoing activity limiting agents.

The catalyst system as described above has been found to be particularly well suited for producing the heterophasic polymer composition of the present disclosure.

Due to the physical properties of the polypropylene composition of the present disclosure, the compositions described herein are well suited for thermoforming and extrusion blow molding applications.

The present invention, thus generally described, will be understood more readily by reference to the following examples, which are provided by way of illustration and are not intended to be limiting of the present invention.

### EXAMPLES

### Example 1

Various different heterophasic polypropylene copolymer samples were produced and tested for various properties including impact strength and haze. The heterophasic copolymers were made generally using the process described above in conjunction with the catalyst described above. In particular, example resins were prepared in a dual reactor gas phase fluidized bed pilot plant. Ziegler-Natta catalyst (CONSISTA® C601 Catalyst from W. R. Grace), Co-catalyst (tri-ethyl aluminum (Teal)), external donor (CONSISTA® D8700 Donor from W. R. Grace), and propylene were fed to the first reactor. For Examples 2-4, ethylene was also fed to the first reactor. The first reactor also had hydrogen feed for all examples, used to control the polymer first phase melt flow rate. The reactor total pressure was maintained constant with nitrogen feed. In the first reactor, the polymer phase ethylene content was controlled by adjustment of the ethylene/propylene gas phase molar ratio, the melt flow rate was controlled by the hydrogen/propylene gas phase molar ratio and the cold xylene solubles was controlled by the cocatalyst/external donor molar ratio. Reactor temperature was maintained at 65° C.

The first polymer phase powder was transferred from the first gas phase reactor to the second gas phase reactor, also being maintained at 65° C. The second reactor had ethylene and propylene feed to control the second phase composition by controlling the propylene/ethylene gas phase molar ratio and hydrogen feed to control the melt flow rate by controlling the hydrogen/ethylene gas phase molar ratio. As with the first reactor, nitrogen was fed to maintain constant reactor pressure.

A twin screw extruder was used to mix in the additive package with the neat polymer produced in the reactor. The additive package included 1000 ppm of pentaerythritol tetrakis(3-(3,5-di-tert-butyl-4-hydroxyphenyl)propionate); 1000 ppm of tris(2,4-ditert-butylphenyl)phosphite; 180 ppm of an acid scavenger DHT-4A obtained from Kisuma; 2000 ppm of glycerol monostearate; and 4000 ppm of a nucleating agent obtained commercially from Milliken as MILLAD® NX®8000. The specimens were made according to ASTM Test D4101 to produce specimens for testing. Testing methods used are described in the above.

The below tables show the following polypropylene compositions that were produced and their following properties.

TABLE 1

| | Composition 1 | Composition 2 | Composition 3 | Composition 4 |
|---|---|---|---|---|
| Phase 1 Et, | 0 | 2 | 1 | 1 |
| wt % | | | | |
| Phase 1 powder | 0.9 | 0.9 | 3.3 | 3.2 |
| MFR, g/10 min | | | | |
| Phase 1 cold | 2.8 | 4.1 | 2.6 | 2.4 |
| XS, wt % | | | | |
| Fraction of | 0.78 | 0.80 | 0.84 | 0.82 |
| Phase 1 | | | | |
| Ethylene in | 15.9 | 13.2 | 11.6 | 14.2 |
| second reactor | | | | |
| Ec wt % | | | | |
| Composition | 3.5 | 4.2 | 2.7 | 2.9 |
| Et, wt % | | | | |
| Composition | 7.1 | 12.2 | 5.6 | 8.7 |
| XS, wt % | | | | |
| Powder MFR | 0.8 | 0.8 | 2.7 | 2.2 |
| MFRp1/MFRp2 | 1.71 | 1.82 | 3.49 | 8.49 |
| Pellet | 1.3 | 1.3 | 3.1 | 2.6 |
| Composition | | | | |
| MFR (g/10 | | | | |
| min) | | | | |
| Flexural | 1040 | 889 | 1357 | 1228 |
| modulus, MPa | | | | |
| IZOD at 23° C., | 706 | 537 | 224 | 416 |
| J/m | | | | |
| Gardner at | 252 | 153 | 181 | 200 |
| 23° C., in · lbs | | | | |
| Gardner at 0° C., | 205 | 189 | — | — |
| in · lbs | | | | |
| Haze, 1 mm | 14.2 | 9 | 10 | 16.8 |

Phase 1 = First polymer phase

TABLE 2

| | Comparative Ex. 1 | Comparative Ex. 2 | Comparative Ex. 3 |
|---|---|---|---|
| Phase 1 Et, wt % | 4.5 | 3.6 | 0 |
| Phase 1 MFR, g/10 | 1.3 | 7.7 | 6 |
| min | | | |
| Phase 1 cold XS, | 7.3 | 2.6 | 1.5 |
| wt % | | | |
| Fraction of Phase 1 | 1 | 1 | 74 |
| Ethylene in second | 0 | 0 | 35.9 |
| reactor Ec wt % | | | |
| Composition Et, wt % | 4.5 | 3.6 | 11.9 |
| Composition cold | 7.3 | 7.7 | 23.4 |
| XS, wt % | | | |
| Composition MFR | 1.3 | 2.6 | 2.3 |
| MFRp1/MFRp2 | — | — | 38.5 |
| Flexural modulus, | 867 | 975 | 1229 |
| MPa | | | |
| IZOD at 23° C., J/m | 385 | 293 | 675 |
| Gardner at 23° C., | 236 | 197 | >250 |
| in · lbs | | | |
| Gardner at 0° C., in · lbs | — | <20 | >250 |
| Haze, 1 mm | 9.8 | 8 | >50 |

Phase 1 = First polymer phase

When Composition 1 and Composition 2 are compared with Comparative Example 1 (material that is outside the scope the ethylene/propylene copolymer in the disclosed in the specification), Compositions 1 and 2 show higher toughness and comparable haze.

When Compositions 3 and Composition 4 are compared with Comparative Example 2 (material that is outside the scope the ethylene/propylene copolymer in the disclosed in the specification), Compositions 3 and 4 show higher stiffness and similar haze and toughness.

When Compositions 1 and Composition 4 are compared with Comparative Example 3, Compositions 1 and 4 show slightly lower similar stiffness/toughness at room temperature but improved haze.

Para. 1. A polypropylene composition comprising:
(a) a first polymer phase comprising a polypropylene homopolymer or random copolymer comprising optionally one or more comonomers in an amount of equal or less than about 3% by weight, based upon the total weight of the propylene homopolymer or copolymer, having a total cold xylene solubles content of from about 2% by weight to about 6% by weight, and having a melt flow rate of about 0.5 g/10 min to about 3 g/10 min; and
(b) a second polymer phase comprising a propylene/ethylene copolymer comprising ethylene in an amount of less than about 18% by weight, based upon the total weight of the propylene/ethylene copolymer;
wherein the ratio of the melt flow rate of the polypropylene homopolymer or random copolymer to the melt flow rate of the propylene/ethylene copolymer is greater than about 1.0; and
wherein the first polymer phase and the second polymer phase are combined to provide the polypropylene composition having a melt flow rate of about 4 g/10 min or less, an ethylene content of less than about 5% by weight, a total cold xylene solubles content of from about 5% by weight to about 20% by weight, a haze at 1 mm of less than about 20%, an IZOD impact strength at 23° C. of greater than about 500 J/m, a Gardner drop impact strength at 0° C. of greater than about 150 inch-lbs, and a flexural modulus of greater than or equal about 800 MPa.

Para. 2. A polypropylene composition comprising:
(a) a first polymer phase comprising a polypropylene homopolymer or random copolymer comprising optionally one or more comonomers in an amount of equal or less than about 1% by weight, based upon the total weight of the propylene homopolymer or copolymer, having a total cold xylene solubles content of less than about 4% by weight, and having a melt flow rate of from about 2 g/10 min to about 5 g/10 min; and
(b) a second polymer phase comprising a propylene/ethylene copolymer comprising ethylene in an amount of less than about 18% by weight, based upon the total weight of the propylene/ethylene copolymer;
wherein the ratio of the melt flow rate of the polypropylene homopolymer or random copolymer to the melt flow rate of the propylene/ethylene copolymer is greater than about 1.0; and
wherein the first polymer phase and the second polymer phase are combined to provide the polypropylene composition having a melt flow rate of about 5 g/10 min or less, an ethylene content of less than about 3.5% by weight, a total cold xylene solubles content of from about 5% by weight to about 15% by weight, a haze at 1 mm of less than about 20%, an IZOD impact strength at 23° C. of greater than about 200 J/m, and a flexural modulus of greater than or equal about 1100 MPa.

Para. 3. The polypropylene composition of Paras. 1 or 2, wherein the first polymer phase comprises a crystalline matrix comprising the polypropylene homopolymer or random copolymer.

Para. 4. The polypropylene composition of any one of Paras. 1-3, wherein the polypropylene composition comprises a heterophasic propylene copolymer.

Para. 5. The polypropylene composition of any one of Paras. 1 and 3-4, wherein the first polymer phase comprises the polypropylene homopolymer or random copolymer comprising one or more comonomers in an amount of from about 0% by weight to about 3% by weight, based upon the total weight of the propylene homopolymer or copolymer.

Para. 6. The polypropylene composition of any one of Paras. 1 and 3-5, wherein the first polymer phase comprises the polypropylene homopolymer or random copolymer having a total cold xylene solubles content of about 2.5% by weight or about 4.8% by weight.

Para. 7. The polypropylene composition of any one of Paras. 1 and 3-6, wherein the first polymer phase comprises the polypropylene homopolymer or random copolymer having a melt flow rate of from about 0.5 g/10 min to about 1.5 g/10 min.

Para. 8. The polypropylene composition of any one of Paras. 1 and 3-7, wherein the polypropylene composition has a melt flow rate of from about 0.5 g/10 min to about 1.5 g/10 min.

Para. 9. The polypropylene composition of any one of Paras. 1 and 3-8, wherein the polypropylene composition has an ethylene content of from about 2% by weight to about 4.5% by weight.

Para. 10. The polypropylene composition of any one of Paras. 1 and 3-9, wherein the polypropylene composition has a total cold xylene solubles content of about 7% by weight or about 12% by weight.

Para. 11. The polypropylene composition of any one of Paras. 1 and 3-10, wherein the polypropylene composition has a haze at 1 mm of from about 5% to about 15%.

Para. 12. The polypropylene composition of any one of Paras. 1 and 3-11, wherein the polypropylene composition has an IZOD impact strength at 23° C. of from about 500 J/m to about 900 J/m.

Para. 13. The polypropylene composition of any one of Paras. 1 and 3-12, wherein the polypropylene composition has a Gardner drop impact strength at 0° C. of from about 150 inch-lbs to about 350 inch-lbs.

Para. 14. The polypropylene composition of any one of Paras. 1 and 3-13, wherein the polypropylene composition has a flexural modulus of from about 800 MPa to about 1300 MPa.

Para. 15. The polypropylene composition of any one of Paras. 2-4, wherein the first polymer phase comprises the polypropylene homopolymer or random copolymer comprising one or more comonomers in an amount of from about 0.5% by weight to about 1% by weight, based upon the total weight of the propylene homopolymer or copolymer.

Para. 16. The polypropylene composition of any one of Paras. 2-4 and 15, wherein the first polymer phase comprises the polypropylene homopolymer or random copolymer having a total cold xylene solubles content of from about 1% by weight to about 3% by weight.

Para. 17. The polypropylene composition of any one of Paras. 2-4 and 15-16, wherein the first polymer phase comprises the polypropylene homopolymer or random copolymer having a melt flow rate of from about 2 g/10 min to about 4 g/10 min.

Para. 18. The polypropylene composition of any one of Paras. 2-4 and 15-17, wherein the polypropylene composition has a melt flow rate of from about 2 g/10 min to about 4 g/10 min.

Para. 19. The polypropylene composition of any one of Paras. 2-4 and 15-18, wherein the polypropylene composition has an ethylene content of from about 2% by weight to about 3.5% by weight.

Para. 20. The polypropylene composition of any one of Paras. 2-4 and 15-19, wherein the polypropylene composition has a total cold xylene solubles content of from about 5.5% by weight or about 12% by weight.

Para. 21. The polypropylene composition of any one of Paras. 2-4 and 15-20, wherein the polypropylene composition has a haze at 1 mm of from about 10% to about 20%.

Para. 22. The polypropylene composition of any one of Paras. 2-4 and 5-21, wherein the polypropylene composition has an IZOD impact strength at 23° C. of from about 200 J/m to about 900 J/m.

Para. 23. The polypropylene composition of any one of Paras. 2-4 and 5-22, wherein the polypropylene composition has a flexural modulus of from about 1200 MPa to about 1600 MPa.

Para. 24. The polypropylene composition of any one of Paras. 1-23, wherein the second polymer phase comprises a propylene/ethylene copolymer comprising ethylene in an amount of from about 10% by weight to about 18% by weight, based upon the total weight of the propylene/ethylene copolymer.

Para. 25. The polypropylene composition of any one of Paras. 1-24, wherein the ratio of the melt flow rate of the polypropylene homopolymer or random copolymer to the melt flow rate of the propylene/ethylene copolymer is from about 1.0 to about 3.0.

Para. 26. The polypropylene composition of any one of Paras. 1-25, wherein the polypropylene composition has a Gardner drop impact strength at 23° C. of greater than about 150 inch-lbs.

Para. 27. The polypropylene composition of any one of Paras. 1-26, wherein the polypropylene composition further comprises one or more of a nucleator, an antacid, and an antioxidant.

Para. 28. The polypropylene composition of Para. 27, wherein the one or more nucleator is present in an amount of about 5000 ppm or lower.

Para. 29. The polypropylene composition of any one of Paras. 1-28, wherein the one or more comonomers present in the polypropylene homopolymer or random copolymer comprises ethylene.

Para. 30. A molded article formed from the polypropylene composition of any one of Paras. 1-29.

Para. 31. The molded article of Para. 30, wherein the molded article is an extrusion blow molded article.

Para. 32. A process for preparing a polypropylene composition of any one of Paras. 1-29 by sequential polymerization in the presence of a Ziegler-Natta catalyst, wherein:
preparing a first polymer phase in first gas phase reactor, and
transferring the first polymer phase to a second gas phase reactor comprising a second polymer phase;
wherein combining the first polymer phase with the second polymer phase provides the polypropylene composition.

Para. 33. A process for preparing a polypropylene composition of any one of Paras. 1-29 comprising:
feeding propylene and optionally one or more comonomers into a first reactor; feeding into the first reactor a catalyst mixture comprising (1) a Ziegler-Natta catalyst, (2) a cocatalyst, and (3) an external donor;
contacting the propylene with the catalyst mixture under first polymerization conditions to polymerize propylene and optionally one or more comonomers to form a first polymer phase comprising a propylene homopolymer or copolymer;
transferring at least a portion of the first polymer phase to a second reactor; and
feeding additional propylene and ethylene into the second reactor to form a second polymer phase;
wherein combining the first polymer phase with the second polymer phase provides the polypropylene composition.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-33. (canceled)

34. A polypropylene composition comprising:
(a) a first polymer phase comprising a polypropylene homopolymer or random copolymer comprising optionally one or more comonomers in an amount of equal or less than about 3% by weight, based upon the total weight of the propylene homopolymer or copolymer, having a total cold xylene solubles content of from about 2% by weight to about 6% by weight, and having a melt flow rate of about 0.5 g/10 min to about 3 g/10 min; and
(b) a second polymer phase comprising a propylene/ethylene copolymer comprising ethylene in an amount of less than about 18% by weight, based upon the total weight of the propylene/ethylene copolymer;
wherein the ratio of the melt flow rate of the polypropylene homopolymer or random copolymer to the melt flow rate of the propylene/ethylene copolymer is greater than about 1.0; and
wherein the first polymer phase and the second polymer phase are combined to provide the polypropylene composition having a melt flow rate of about 4 g/10 min or less, an ethylene content of less than about 5% by weight, a total cold xylene solubles content of from about 5% by weight to about 20% by weight, a haze at 1 mm of less than about 20%, an IZOD impact strength at 23° C. of greater than about 500 J/m, a Gardner drop impact strength at 0° C. of greater than about 150 inch-lbs, and a flexural modulus of greater than or equal about 800 MPa.

35. A polypropylene composition comprising:
(a) a first polymer phase comprising a polypropylene homopolymer or random copolymer comprising optionally one or more comonomers in an amount of equal or less than about 1% by weight, based upon the total weight of the propylene homopolymer or copolymer, having a total cold xylene solubles content of less than about 4% by weight, and having a melt flow rate of from about 2 g/10 min to about 5 g/10 min; and
(b) a second polymer phase comprising a propylene/ethylene copolymer comprising ethylene in an amount of less than about 18% by weight, based upon the total weight of the propylene/ethylene copolymer;
wherein the ratio of the melt flow rate of the polypropylene homopolymer or random copolymer to the melt flow rate of the propylene/ethylene copolymer is greater than about 1.0; and
wherein the first polymer phase and the second polymer phase are combined to provide the polypropylene composition having a melt flow rate of about 5 g/10 min or less, an ethylene content of less than about 3.5% by weight, a total cold xylene solubles content of from about 5% by weight to about 15% by weight, a haze at 1 mm of less than about 20%, an IZOD impact strength at 23° C. of greater than about 200 J/m, and a flexural modulus of greater than or equal about 1100 MPa.

36. The polypropylene composition of claim 34, wherein the first polymer phase comprises a crystalline matrix comprising the polypropylene homopolymer or random copolymer.

37. The polypropylene composition of claim 34, wherein the polypropylene composition comprises a heterophasic propylene copolymer.

38. The polypropylene composition of claim 34, wherein the first polymer phase comprises the polypropylene homopolymer or random copolymer comprising one or more comonomers in an amount of from about 0% by weight to about 3% by weight, based upon the total weight of the propylene homopolymer or copolymer, having a total cold xylene solubles content of about 2.5% by weight or about 4.8% by weight, and/or having a melt flow rate of from about 0.5 g/10 min to about 1.5 g/10 min.

39. The polypropylene composition of claim 34, wherein the polypropylene composition has a melt flow rate of from about 0.5 g/10 min to about 1.5 g/10 min, an ethylene content of from about 2% by weight to about 4.5% by weight, and/or a total cold xylene solubles content of about 7% by weight or about 12% by weight.

40. The polypropylene composition of claim 34, wherein the polypropylene composition has a haze at 1 mm of from about 5% to about 15%, an IZOD impact strength at 23° C. of from about 500 J/m to about 900 J/m, a Gardner drop impact strength at 0° C. of from about 150 inch-lbs to about 350 inch-lbs, and/or a flexural modulus of from about 800 MPa to about 1300 MPa.

41. The polypropylene composition of claim 35, wherein the first polymer phase comprises the polypropylene homopolymer or random copolymer comprising one or more comonomers in an amount of from about 0.5% by weight to about 1% by weight, based upon the total weight of the propylene homopolymer or copolymer, having a total cold xylene solubles content of from about 1% by weight to about 3% by weight, and/or having a melt flow rate of from about 2 g/10 min to about 4 g/10 min.

42. The polypropylene composition of claim 35, wherein the polypropylene composition has a melt flow rate of from about 2 g/10 min to about 4 g/10 min, an ethylene content of from about 2% by weight to about 3.5% by weight, and/or a total cold xylene solubles content of from about 5.5% by weight or about 12% by weight.

43. The polypropylene composition of claim 35, wherein the polypropylene composition has a haze at 1 mm of from about 10% to about 20%, an IZOD impact strength at 23° C. of from about 200 J/m to about 900 J/m, and/or a flexural modulus of from about 1200 MPa to about 1600 MPa.

44. The polypropylene composition of claim 34, wherein the second polymer phase comprises a propylene/ethylene copolymer comprising ethylene in an amount of from about 10% by weight to about 18% by weight, based upon the total weight of the propylene/ethylene copolymer.

45. The polypropylene composition of claim 34, wherein the ratio of the melt flow rate of the polypropylene homopolymer or random copolymer to the melt flow rate of the propylene/ethylene copolymer is from about 1.0 to about 3.0.

46. The polypropylene composition of claim 34, wherein the polypropylene composition has a Gardner drop impact strength at 23° C. of greater than about 150 inch-lbs.

47. The polypropylene composition of claim 34, wherein the polypropylene composition further comprises one or more of a nucleator, an antacid, and an antioxidant.

48. The polypropylene composition of claim 47, wherein the one or more nucleator is present in an amount of about 5000 ppm or lower.

49. The polypropylene composition of claim 34, wherein the one or more comonomers present in the polypropylene homopolymer or random copolymer comprises ethylene.

50. A molded article formed from the polypropylene composition of claim 34.

51. The molded article of claim 50, wherein the molded article is an extrusion blow molded article.

52. A process for preparing the polypropylene composition of claim 34 by sequential polymerization in the presence of a Ziegler-Natta catalyst, wherein:
preparing a first polymer phase in first gas phase reactor, and
transferring the first polymer phase to a second gas phase reactor comprising a second polymer phase;
wherein combining the first polymer phase with the second polymer phase provides the polypropylene composition.

53. A process for preparing the polypropylene composition of claim 34 comprising:
feeding propylene and optionally one or more comonomers into a first reactor; feeding into the first reactor a catalyst mixture comprising (1) a Ziegler-Natta catalyst, (2) a cocatalyst, and (3) an external donor;
contacting the propylene with the catalyst mixture under first polymerization conditions to polymerize propylene and optionally one or more comonomers to form a first polymer phase comprising a propylene homopolymer or copolymer;
transferring at least a portion of the first polymer phase to a second reactor; and
feeding additional propylene and ethylene into the second reactor to form a second polymer phase;
wherein combining the first polymer phase with the second polymer phase provides the polypropylene composition.
